(19) United States
(12) Patent Application Publication
(10) Pub. No.: US 2026/0164271 A1
(43) Pub. Date: Jun. 11, 2026

(54) APPARATUSES AND METHODS FOR FACILITATING REPRESENTATIONS OF NETWORK/SYSTEM PERFORMANCE IN RESPECT OF A UTILIZATION OF COMMUNICATION SERVICES AND APPLICATIONS

(71) Applicants: AT&T Intellectual Property I, L.P., Atlanta, GA (US); AT&T Mobility II LLC, Atlanta, GA (US)

(72) Inventors: Stephen Hardin, Suwanee, GA (US); Yupeng Jia, South Pasadena, CA (US); Anthony Dalby, Carrollton, TX (US); James H. Pratt, Round Rock, TX (US)

(73) Assignees: AT&T Intellectual Property I, L.P., Atlanta, GA (US); AT&T Mobility II LLC, Atlanta, GA (US)

(21) Appl. No.: 18/976,619

(22) Filed: Dec. 11, 2024

(51) Int. Cl. H04W 24/08; H04W 24/02

(52) U.S. Cl. CPC H04W 24/08; H04W 24/02

(57) ABSTRACT

Aspects of the subject disclosure may include, for example, obtaining first data, analyzing the first data to delineate a plurality of zones including a first zone and a second zone, wherein the first zone and the second zone are distinguishable from one another in terms of at least one wireless network performance characteristic, obtaining, from a communication device, a request for wireless network performance data pertaining to a specified location that is within a threshold distance of the first zone, the second zone, or a combination thereof, based on the obtaining of the request, processing the request to identify second data corresponding to the wireless network performance data, wherein at least a portion of the second data is based on the first data, and transmitting the second data. Other embodiments are disclosed.

### FIELD OF THE DISCLOSURE

The subject disclosure relates to apparatuses and methods for facilitating representations of network/system performance in respect of a utilization of communication services and applications.

### BACKGROUND

Vast communication networks and systems, and various communication devices, are used to provision communication services. A wireless communication device is an example of a client device/user equipment that enables a user to access communication services, while still allowing the user an opportunity to move or change locations.

There are a multitude of factors and parameters that influence/impact the performance of a communication network/system, in relation to a utilization of communication services and applications. A failure to identify what those factors/parameters are, much less understand/comprehend how those factors/parameters influence/impact performance, can lead to a degraded (e.g., a suboptimal) quality of service or quality of experience for users in respect of such communication services and applications.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system in accordance with various aspects described herein.

FIG. 2B depicts a presentation with delineated zones associated with one or more performance characteristics of a wireless network or system in accordance with aspects of this disclosure.

FIG. 2C depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for facilitating a visualization of network/system performance and identifying various factors, parameters, or conditions that influence/impact network/system performance. Other embodiments are described in the subject disclosure.

One or more aspects of the subject disclosure include, in whole or in part, obtaining first data; analyzing the first data to delineate a plurality of zones including a first zone and a second zone, wherein the first zone and the second zone are distinguishable from one another in terms of at least one wireless network performance characteristic; obtaining, from a communication device, a request for wireless network performance data pertaining to a specified location that is within a threshold distance of the first zone, the second zone, or a combination thereof; based on the obtaining of the request, processing the request to identify second data corresponding to the wireless network performance data, wherein at least a portion of the second data is based on the first data; and transmitting the second data.

One or more aspects of the subject disclosure include, in whole or in part, defining a plurality of zones, wherein each zone of the plurality of zones is associated with a respective range of values for at least one wireless network performance characteristic of a wireless network; obtaining a request from a communication device associated with an operator of the wireless network, the request pertaining to a specified location that is included within at least one zone of the plurality of zones; based on the obtaining of the request, obtaining data that is representative of a performance of the wireless network within the at least one zone; and transmitting second data to the communication device, wherein the second data is based on the data.

One or more aspects of the subject disclosure include, in whole or in part, transmitting, by a processing system including a processor, a request for information associated with operations of a first wireless network; obtaining, by the processing system and based on the transmitting of the request, first data pertaining to a first performance characteristic of the first wireless network and second data pertaining to a second performance characteristic of a second wireless network; processing, by the processing system, the first data and the second data to generate a presentation that includes a representation of the first performance characteristic and the second performance characteristic; and presenting, by the processing system, the presentation.

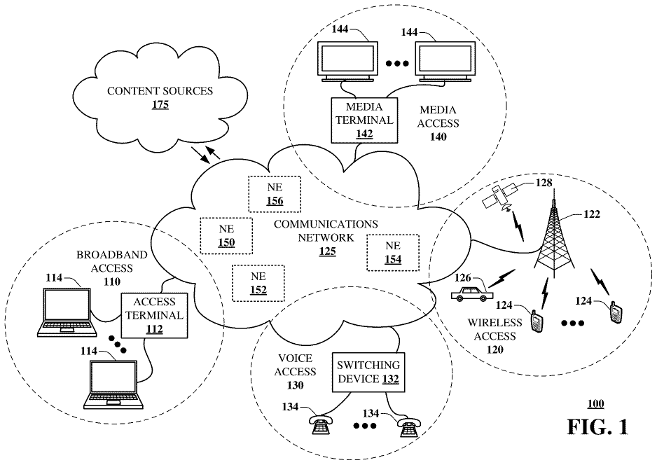

Referring now to FIG. 1, a block diagram is shown illustrating an example, non-limiting embodiment of a system 100 in accordance with various aspects described herein. For example, the system 100 can facilitate, in whole or in part, obtaining first data, analyzing the first data to delineate a plurality of zones including a first zone and a second zone, wherein the first zone and the second zone are distinguishable from one another in terms of at least one wireless network performance characteristic, obtaining, from a communication device, a request for wireless network performance data pertaining to a specified location that is within a threshold distance of the first zone, the second zone, or a combination thereof, based on the obtaining of the request, processing the request to identify second data corresponding to the wireless network performance data, wherein at least a portion of the second data is based on the first data, and transmitting the second data. The system 100 can facilitate, in whole or in part, defining a plurality of zones, wherein each zone of the plurality of zones is associated with a respective range of values for at least one wireless network performance characteristic of a wireless network, obtaining a request from a communication device associated with an operator of the wireless network, the request pertaining to a specified location that is included within at least one zone of the plurality of zones, based on the obtaining of the request, obtaining data that is representative of a performance of the wireless network within the at least one zone, and transmitting second data to the communication device, wherein the second data is based on the data. The system 100 can facilitate, in whole or in part, transmitting, by a processing system including a processor, a request for information associated with operations of a first wireless network, obtaining, by the processing system and based on the transmitting of the request, first data pertaining to a first performance characteristic of the first wireless network and second data pertaining to a second performance characteristic of a second wireless network, processing, by the processing system, the first data and the second data to generate a presentation that includes a representation of the first performance characteristic and the second performance characteristic, and presenting, by the processing system, the presentation.

In particular, in FIG. 1 a communications network 125 is presented for providing broadband access 110 to a plurality of data terminals 114 via access terminal 112, wireless access 120 to a plurality of mobile devices 124 and vehicle 126 via base station or access point 122 (and/or via satellite 128), voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices. In various embodiments, the satellite 128 can be configured for bi-directional communication with one or more access points, with one or more base stations, and/or with one or more mobile devices (e.g., direct-to-cell). In various embodiments, the satellite 128 can comprise a Low Earth Orbit (LEO) satellite or a Geostationary Orbit (GEO) satellite.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

By way of introduction, aspects of this disclosure enable a wireless network/system operator or service provider to visualize levels or tiers of performance that are being provided to users (e.g., customers or subscribers), or analogously, devices of such users. In some embodiments, augmented reality or virtual reality technologies may be used to facilitate a presentation of network/system performance characteristics. Aspects of the presentation may enable engineers, field technicians, and the like, to understand/comprehend how various factors or parameters influence performance, which in turn can enable such engineers/technicians to enact network/system modifications, remedies, updates, enhancements and the like. In some embodiments, prospective network/system changes or modifications may be trialed or simulated, and an assessment may be obtained/provided of the impact/influence of those changes on network/system performance. In this manner, a network/system operator or service provider may be able to gain insight into how a potential change or modification may impact performance in advance of having to incur the cost, expense, or risk of actually deploying/implementing the change or modification.

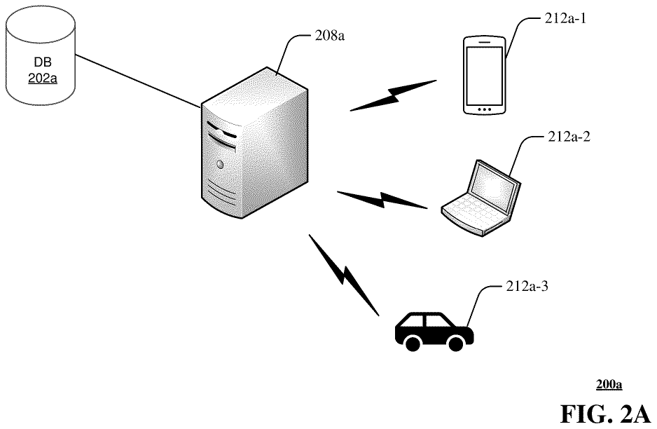

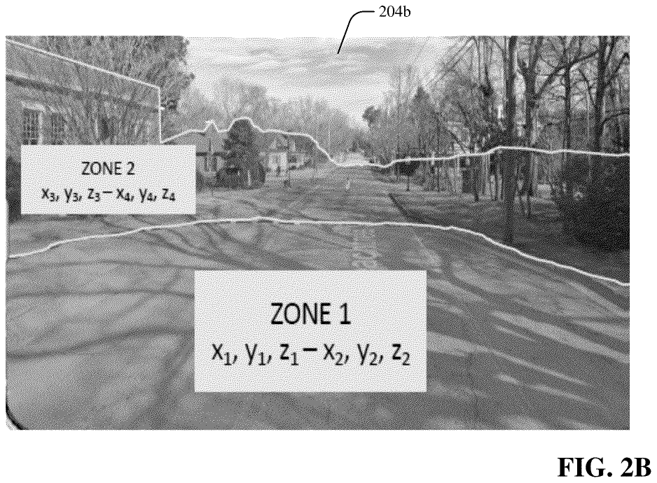

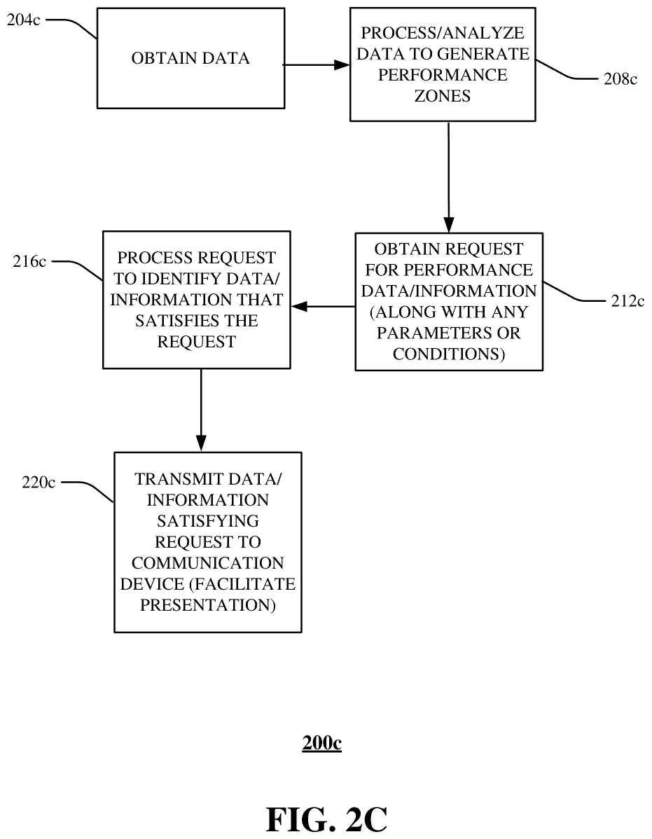

With the foregoing in mind, reference may now be made to FIG. 2A, which is a block diagram illustrating an example, non-limiting embodiment of a system 200a in accordance with various aspects described herein. In some embodiments, one or more parts/portions of the system 200a may be combined with, or operatively overlaid upon, one or more parts/portions of the system 100 of FIG. 1.

The system 200a may include one or more devices or entities, such as for example a database (DB) 202a, a network/system node 208a (e.g., a server), and one or more client devices/user equipment (UEs), such as a first client device 212a-1, a second client device 212a-2, and a third client device 212a-3. In some embodiments, the node 208a may be included at or near an edge of a network/system associated with the system 200a, which may be useful in facilitating low-latency communications/signaling between the node 208a and client devices (e.g., the client devices 212a-1, 212a-2, and 212a-3). In some embodiments, the node 208a may be included as part of a cloud computing platform/topology, as part of a back-end server system/farm, etc. The client devices 212a-1, 212a-2, and 212a-3 may include any type or kind (e.g., make and model) of device. For example, in an illustrative embodiment the first client device 212a-1 may include a smartphone, the second client device 212a-2 may include a laptop, and the third client device 212a-3 may include (or may be incorporated as part of) a connected vehicle. The use/representation of three client devices in FIG. 2A is illustrative, which is to say that more or fewer than three client devices may be included in a given embodiment.

In operation, and as described in further detail below, the DB 202a may be used to store information/data pertaining to the client devices 212a-1, 212a-2, and 212a-3, and other devices, potentially as part of one or more profiles (e.g., each client device may have a specific/dedicated profile). The data/information associated with a given client device may include an identification of a type or kind of the client device, versions of applications or an operating system of the client device, etc. In some embodiments, the DB 202a may be used to store data/information pertaining to network/system performance (such as characteristics of performance detected by the client devices, or other devices).

The data/information of the DB 202a may be at least partially sourced from an application (which may, illustratively, be referred to herein as a wireless performance app) executing on a respective client device. The data/information may include: an identification of a location of the client device, one or more timestamps associated with the location, applications or services (e.g., communication services) that are executed/utilized while at the location, other users or devices (e.g., “contacts”) that the client device is in communication with while at the location (potentially inclusive of the form of the communication that is used (e.g., voice, text, email, videoconferencing, etc.)), etc.

Over a period of time, the information/data for the client devices may be collected and combined with mapping location information, which in turn may establish a record of the locations of the respective client devices in conjunction with a record of a utilization of the respective client devices. The relative amounts of time during which a client device is present in/at certain locations or areas may be represented in one or more forms, such as a heat map with a longer duration of presence being signified or distinguished from a shorter duration or presence (such as by way of color coding, for example). In some embodiments, the heat map may be included/incorporated as part of a graphic or visual presentation. In this manner, it may be easily perceived as to which areas or locations are typically important for the client device (with a given profile or configuration) to have a high-quality performance/experience versus other areas or locations that the client device is rarely, if ever, present.

The wireless performance app (or another application or app) may contribute/provide information/data to the node 208a (or another node) for storage in the DB 202a describing wireless performance characteristics for/detected by the associated client device. For example, the characteristics may include bandwidth data, signal strength data, latency data, frequency band data, antenna data, etc., for connections over a period of time, potentially in conjunction with location and timestamp identifiers. These wireless performance characteristics may be collected by the wireless performance app as part of a background task, which is to say that the associated client device might not present (indicators of the) characteristics to a user. It is noted that this process of collecting information/data describing wireless performance characteristics may occur for multiple devices (e.g., multiple client devices), where such devices may be associated with one or more users. In this respect, a rich/voluminous knowledgebase of performance may be generated or established within the data of the DB 202a.

The wireless performance characteristics may be analyzed by, e.g., the node 208a (or another node) to define geographical regions or zones that reflect similar levels of wireless performance (e.g., levels of wireless performance that are within a threshold of one another or within a range of values). It is noted that the regions/zones of wireless performance might not be static in nature, but may be dynamic in nature. For example, the regions/zones of wireless performance may be updated or modified as additional information/data is obtained/acquired. Thus, a first location included in a first zone at a first point in time might not be included as part of the first zone at another point in time. Similarly, a second location that is not included in the first zone at the first point in time may be included as part of the first zone at the second point in time (or another point in time).

The wireless performance regions/zones may be examined to determine/identify those areas or locations that provide good wireless performance (as potentially expressed relative to one or more thresholds)—e.g., good coverage and bandwidth, or analogously those areas or locations that suffer from poor coverage or bandwidth. It is noted that various parameters/factors may influence the wireless performance that is obtained/realized, such as for example geographic or created landscapes (e.g., mountains or urban canyons), network/system infrastructure (e.g., tower or base station) placements, etc. The definition of the wireless performance regions/zones may be stored as part of the DB 202a.

The wireless performance regions/zones may be defined by a range of geographical coordinates. For example, in a three-dimensional space a first zone (Zone 1) may be defined by a range of (Cartesian) coordinates—e.g., X1, Y1, Z1 through X2, Y2, Z2. Similarly, a second zone (Zone 2) may be defined by a range of Cartesian coordinates of the form X3, Y3, Z3 through X4, Y4, and Z4. It is noted that, in practice, a zone may have an irregular shape, that may require a more complex expression to define its contours or perimeter. Further, it is noted that the number or count of zones may be based on a particular degree of resolution that is needed. For example, in relation to facilitating an application or communication service that requires a very high bandwidth and low latency (as potentially expressed relative to one or more thresholds), a zone that meets those requirements may tend to be relatively small in size/scope relative to a zone associated with another application or communication service that provides for looser or more relaxed requirements.

To demonstrate aspects of the foregoing, reference may now be made to FIG. 2B, which is representative of an image that may be presented on a device of, e.g., an engineer or technician associated with a communication network/system operator or service provider. In particular, the first zone (Zone 1) and the second zone (Zone 2) set forth above are depicted in FIG. 2B. The definition or contours of the zones shown in FIG. 2B may be based on, e.g., an analysis of the data/information in the DB 202a by the node 208a of FIG. 2A. The presentation shown in FIG. 2B may leverage/utilize augmented reality or virtual reality technologies to facilitate an overlay of the first zone and the second zone relative to a depiction of a scene 204b (e.g., a roadway with buildings nearby). The scene 204b may correspond to an image that was previously captured or may correspond to a live or real-time shot (as may be facilitated by a camera of a device) as the engineer/technician is out in the field. In this respect, it is noted that what is shown for purposes of the scene 204b may change as the engineer/technician rotates (or otherwise modifies) his/her field of view, such as by changing a direction or an orientation of a camera.

Various types of data or information indicative of network/system performance may be included or incorporated as part of the presentation shown in FIG. 2B. For example, and without limitation, data or information may be overlaid pertaining to: signal strength, noise, interference, frequencies or frequency bands that are/were utilized, indicators of networks/systems operating in the area/region depicted in the scene 204b, radio access technologies (RATs) that are available or were utilized, etc. In some embodiments, an engineer or technician may be able to obtain a visualization of the network/system performance data in conjunction with one or more parameters, or along one or more dimensions or paradigms. For example, the engineer/technician may have an option for showing network/system performance data as it relates to a device of a specific make and model (or other specified configuration). In another instance, the engineer/technician may have an option for showing the network/system performance data for a given, specified set or range of dates or times. The various types of options that may be available for selection may be facilitated based on the wealth/depth/volume of data/information (or analogously, metadata) that may be stored in/by, e.g., the DB 202a of FIG. 2A.

In some embodiments, a digital twin of a geographic area (such as, for example, the geographic area corresponding to the scene 204b shown in FIG. 2B) may be generated and used in conjunction with network/system performance analyses. Light Detection and Ranging (LiDAR) technology may be used to help develop a three-dimensional model of the physical world for the geographic area. The digital twin may provide insight into how performance may be impacted by buildings, signage, and other objects, for example. Further, the digital twin may be used to help visualize how performance may be enhanced (or, analogously, degraded) by being present inside of a building (e.g., an office, a house or apartment, etc.) versus being outside of that building. Still further, many buildings offer support for Wi-Fi communications (by way of a gateway or router, for example) with limited communication ranges. In this respect, the inclusion of the buildings as part of the digital twin may be used to signify a percentage of data transactions/conveyances occurring over a first network (e.g., a Wi-Fi network) versus other transactions/conveyances (such as data transactions/conveyances occurring via one or more other networks—e.g., a cellular network).

In some embodiments, an artificial intelligence (AI) agent, or the like, may be utilized or supported. For example, and armed with the data/information of the DB 202a, a technician, an engineer, or the like (generally, a user) may be able to formulate a query, such as “Can you show me all the zones where signal strength was detected as being less than −60dBM last week in this neighborhood?”). The query may be translated into text, machine language, or the like, and a search may be performed against the data/information of the DB 202a (potentially in conjunction with data/information obtained from other sources) to identify data/information that may be pertinent to the query (with appropriate context being applied to interpret or resolve the phrases “last week” and “in this neighborhood” included in the expression of the query in this example). Thereafter, an analysis may be performed by, e.g., the node 208a, to identify results that satisfy the query. The results may be presented in one or more forms or in conjunction with one or more formats—e.g., as a report, as a message, as a displayed graphic or image, using audio or video, etc. The process of utilizing the AI agent may be iterative in nature. For example, experience may guide an engineer or technician to ask follow-up queries of the AI agent based on one or more results that are returned in respect of one or more prior queries. In this manner, the engineer or technician may be able to identify, or home in on, where network/system performance issues or shortcomings may exist and may have an opportunity to explore potential modifications (e.g., remedies or enhancements/improvements) in view of the same.

As described above, in some embodiments support may be included/provided for modeling modifications, such as modifications that are expected or intended to facilitate improvements or enhancements in performance. For example, and assuming that a number of modifications are available as candidate modifications (e.g., changing a frequency or frequency band, changing a transmission power level, changing a receiver sensitivity level, changing a modulation/demodulation scheme, changing an encryption/decryption scheme, commissioning or decommissioning infrastructure (e.g., a tower or base station), changing an application or operating system version, etc.), the candidate modifications may be subjected to modeling or simulation, potentially as part of one or more presentations (e.g., a presentation accompanied by augmented reality or virtual reality overlays demonstrating the impact of the modification(s) on performance).

Referring now to FIG. 2C, an illustrative embodiment of a method 200c in accordance with various aspects described herein is shown. The method 200c may be implemented or executed, in whole or in part, in conjunction with one or more systems, devices, and/or components, such as for example the systems, devices, and components set forth herein. In some embodiments, the method 200c may be wholly or partially implemented or executed via one or more processing systems, where each such processing system may include one or more processors. Further, in some embodiments, operations of the method 200c may be embodied as instructions that may be executed by one or more processing systems to obtain/realize the functionality associated therewith. The instructions may be stored in one or more forms and/or in respect of one or more entities, such as a memory, a transitory or non-transitory computer-readable or machine-readable medium, etc. Various operations facilitated via the method 200c are described below in relation to the blocks shown in FIG. 2C. In some embodiments, one or more blocks or operations may be based on one or more other blocks or operations.

In block 204c, data may be obtained. The data obtained as part of block 204c may be acquired from one or more devices, such as one or more client devices. The data may include one or more identifications of: an identifier of the device that is providing or supplying the data, a configuration of the device, a location of the device, a time (or timestamp) when the device is at the location, signal characteristics (e.g., signal strength) associated with one or more measured or detected signals, networks/systems that are present or available, etc. The data may include indications of applications or communication services that were utilized or accessed.

In block 208c, the data obtained as part of block 204c may be processed or analyzed. The analysis may be facilitated via a use of one or more models, algorithms, technologies, etc. For example, the analysis of block 208c may be facilitated via a use of machine learning, artificial intelligence, or a combination thereof. The analysis of block 208c may yield/generate indications of one or more performance zones, such as the zones described above. The zones may be distinguished from one another in terms of one or more parameters, factors, or characteristics.

In block 212c, a request may be obtained to present performance information/data pertaining to a specified location. The specified location may be identified by one or more coordinates (e.g., a location X, Y, Z in a three-dimensional space). In some embodiments, the specified location may be inferred or based on a location of a communication device (such as a communication device belonging to, or associated with, an engineer or technician). In some embodiments, the specified location may be defined or established based on a user-generated input.

As part of block 212c, the request may specify that particular types of data or information be provided. For example, it may be the case that a technician or engineer only wants to see network/system performance data/information for a particular type or kind of client device or user equipment.

In block 216c, the request of block 212c may be processed/analyzed to identify data/information that meets/satisfies any parameters or conditions associated with, or specified as part of, the request.

In block 220c, the data/information that is identified as part of block 216c may be provided/transmitted to, e.g., a communication device associated with the request of block 212c (or another device). The providing of the data/information as part of block 220c may facilitate a generation or rendering of one or more presentations, such as the presentations described above. As part of a presentation of block 220c, one or more performance zones may be denoted/delineated. A given performance zone may include performance characteristics that are similar (e.g., data points representative of performance characteristics within a threshold of one another, or performance characteristics with values being contained within a range of values).

Aspects of the method 200c may be iterative in nature. For example, and as described above, a technician or engineer may be able to simulate the impact that a proposed/potential modification may have on network/system performance. The impact may be represented as a modification to features associated with a given performance zone (or a set of performance zones).

While for purposes of simplicity of explanation, the respective processes are shown and described as a series of blocks in FIG. 2C, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Aspects of this disclosure may facilitate an artificial intelligence (AI) and/or machine learning (ML) based approach towards supporting and maintaining wireless access as part of provisioning communication services. A customized or tailored approach may be utilized, whereby indicators of network/system performance may be analyzed/processed to select (values for) parameters to facilitate a communication service for a given user or device (or a given set of users or devices). A given user or given device may benefit from performance indicators reported by other users or devices. Furthermore, configurations of devices, applications, and/or network/system resources may be based on historical data/information and/or current data/information, which may lead to more accurate/precise resource allocations/assignments.

Various embodiments of this disclosure may support an augmented reality or virtual reality presentation of data/information indicative of network or system performance. Aspects of this disclosure may include a presentation of a geographical area or region, with performance characteristics being provided as an overlay or supplement. Technicians and engineers may gain a better appreciation and understanding of the various factors, parameters, conditions, and circumstances that may impact/influence network/system performance, which in turn may help to facilitate enhancements or improvements in a provisioning of communication services. A utilization of zones, or other markers/indicators, may help a user to visualize where, when, and how performance changes, potentially on a quantitative and/or qualitative basis.

In brief, and as demonstrated herein, the various aspects of this disclosure may be utilized as part of various practical applications representative of substantial improvements to technology. As such, the various aspects of this disclosure are not directed to abstract ideas. As one of skill in the art will appreciate, the various aspects of this disclosure are directed to, and encompass, significantly more than any abstract idea standing alone. Indeed, the various aspects of this disclosure facilitate a generation of transformative, useful, concrete, and tangible results. Further, the various aspects of this disclosure may leverage technologies (e.g., artificial intelligence, machine learning) in relation to particular machines or apparatuses to facilitate enhanced knowledge that might otherwise be lacking. Stated differently, users, network/system operators, or service providers might not even be aware of the circumstances or conditions influencing/impacting quality of service or quality of experience, such that quality of service or quality of experience may suffer in the absence of a use of such machines or apparatuses that are able to discern/account for such circumstances and conditions.

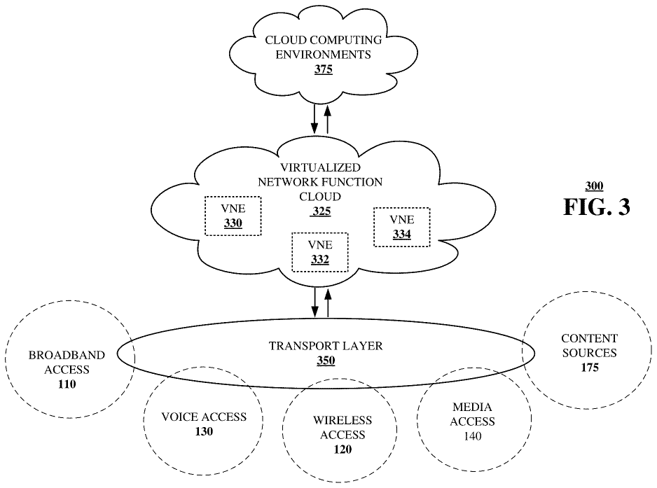

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200a, and method 200c presented in FIGS. 1, 2A, and 2C. For example, the virtualized communication network 300 can facilitate, in whole or in part, obtaining first data, analyzing the first data to delineate a plurality of zones including a first zone and a second zone, wherein the first zone and the second zone are distinguishable from one another in terms of at least one wireless network performance characteristic, obtaining, from a communication device, a request for wireless network performance data pertaining to a specified location that is within a threshold distance of the first zone, the second zone, or a combination thereof, based on the obtaining of the request, processing the request to identify second data corresponding to the wireless network performance data, wherein at least a portion of the second data is based on the first data, and transmitting the second data. The virtualized communication network 300 can facilitate, in whole or in part, defining a plurality of zones, wherein each zone of the plurality of zones is associated with a respective range of values for at least one wireless network performance characteristic of a wireless network, obtaining a request from a communication device associated with an operator of the wireless network, the request pertaining to a specified location that is included within at least one zone of the plurality of zones, based on the obtaining of the request, obtaining data that is representative of a performance of the wireless network within the at least one zone, and transmitting second data to the communication device, wherein the second data is based on the data. The virtualized communication network 300 can facilitate, in whole or in part, transmitting, by a processing system including a processor, a request for information associated with operations of a first wireless network, obtaining, by the processing system and based on the transmitting of the request, first data pertaining to a first performance characteristic of the first wireless network and second data pertaining to a second performance characteristic of a second wireless network, processing, by the processing system, the first data and the second data to generate a presentation that includes a representation of the first performance characteristic and the second performance characteristic, and presenting, by the processing system, the presentation.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

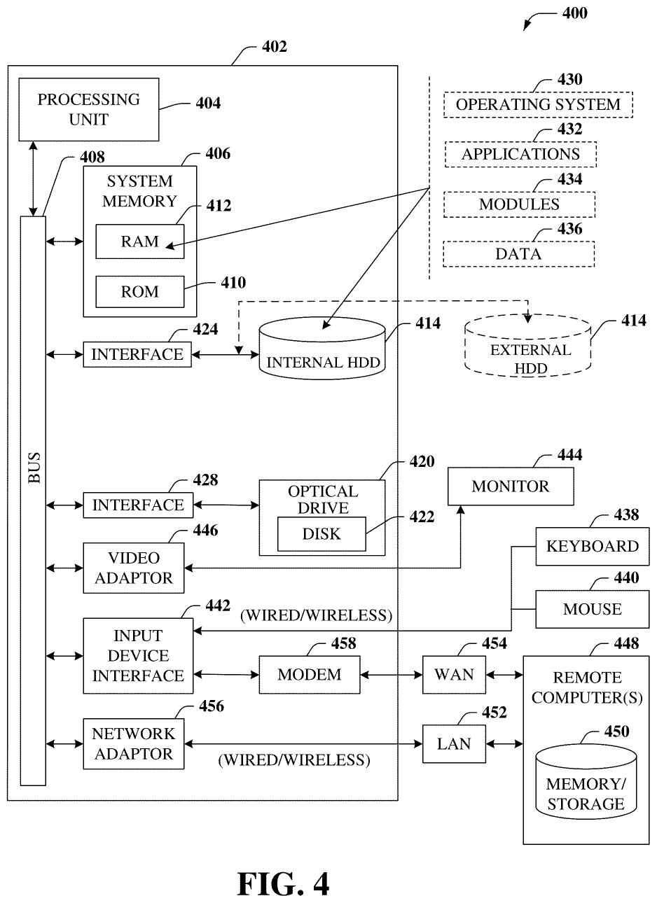

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, the computing environment 400 can facilitate, in whole or in part, obtaining first data, analyzing the first data to delineate a plurality of zones including a first zone and a second zone, wherein the first zone and the second zone are distinguishable from one another in terms of at least one wireless network performance characteristic, obtaining, from a communication device, a request for wireless network performance data pertaining to a specified location that is within a threshold distance of the first zone, the second zone, or a combination thereof, based on the obtaining of the request, processing the request to identify second data corresponding to the wireless network performance data, wherein at least a portion of the second data is based on the first data, and transmitting the second data. The computing environment 400 can facilitate, in whole or in part, defining a plurality of zones, wherein each zone of the plurality of zones is associated with a respective range of values for at least one wireless network performance characteristic of a wireless network, obtaining a request from a communication device associated with an operator of the wireless network, the request pertaining to a specified location that is included within at least one zone of the plurality of zones, based on the obtaining of the request, obtaining data that is representative of a performance of the wireless network within the at least one zone, and transmitting second data to the communication device, wherein the second data is based on the data. The computing environment 400 can facilitate, in whole or in part, transmitting, by a processing system including a processor, a request for information associated with operations of a first wireless network, obtaining, by the processing system and based on the transmitting of the request, first data pertaining to a first performance characteristic of the first wireless network and second data pertaining to a second performance characteristic of a second wireless network, processing, by the processing system, the first data and the second data to generate a presentation that includes a representation of the first performance characteristic and the second performance characteristic, and presenting, by the processing system, the presentation.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), and an optical disk drive 420, (e.g., reading a CD-ROM disk 422 or, to read from or write to other high-capacity optical media such as the DVD). The HDD 414 and optical disk drive 420 can be connected to the system bus 408 by a hard disk drive interface 424, and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

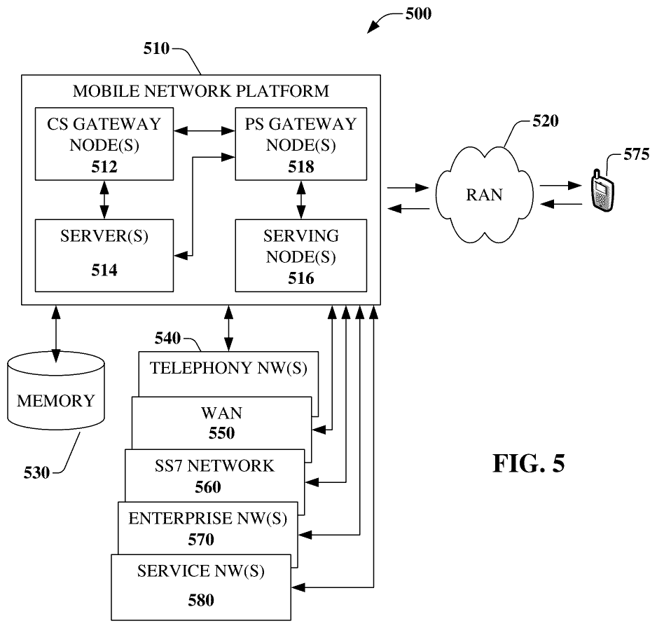

Turning now to FIG. 5, an embodiment 500 of a mobile network platform 510 is shown that is an example of network elements 150, 152, 154, 156, and/or VNEs 330, 332, 334, etc. For example, the platform 510 can facilitate, in whole or in part, obtaining first data, analyzing the first data to delineate a plurality of zones including a first zone and a second zone, wherein the first zone and the second zone are distinguishable from one another in terms of at least one wireless network performance characteristic, obtaining, from a communication device, a request for wireless network performance data pertaining to a specified location that is within a threshold distance of the first zone, the second zone, or a combination thereof, based on the obtaining of the request, processing the request to identify second data corresponding to the wireless network performance data, wherein at least a portion of the second data is based on the first data, and transmitting the second data. The platform 510 can facilitate, in whole or in part, defining a plurality of zones, wherein each zone of the plurality of zones is associated with a respective range of values for at least one wireless network performance characteristic of a wireless network, obtaining a request from a communication device associated with an operator of the wireless network, the request pertaining to a specified location that is included within at least one zone of the plurality of zones, based on the obtaining of the request, obtaining data that is representative of a performance of the wireless network within the at least one zone, and transmitting second data to the communication device, wherein the second data is based on the data. The platform 510 can facilitate, in whole or in part, transmitting, by a processing system including a processor, a request for information associated with operations of a first wireless network, obtaining, by the processing system and based on the transmitting of the request, first data pertaining to a first performance characteristic of the first wireless network and second data pertaining to a second performance characteristic of a second wireless network, processing, by the processing system, the first data and the second data to generate a presentation that includes a representation of the first performance characteristic and the second performance characteristic, and presenting, by the processing system, the presentation.

In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

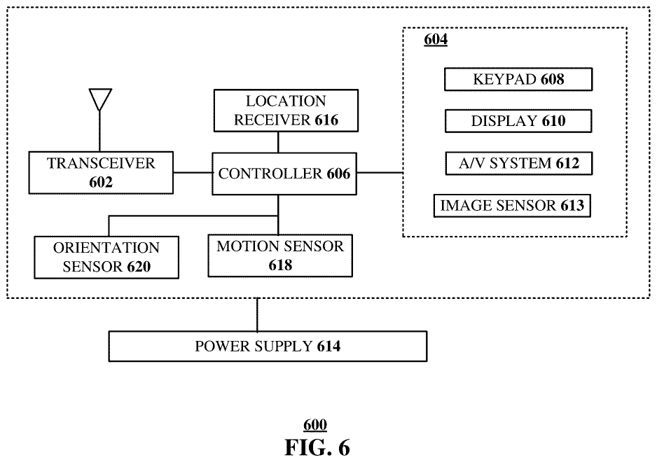

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, the computing device 600 can facilitate, in whole or in part, obtaining first data, analyzing the first data to delineate a plurality of zones including a first zone and a second zone, wherein the first zone and the second zone are distinguishable from one another in terms of at least one wireless network performance characteristic, obtaining, from a communication device, a request for wireless network performance data pertaining to a specified location that is within a threshold distance of the first zone, the second zone, or a combination thereof, based on the obtaining of the request, processing the request to identify second data corresponding to the wireless network performance data, wherein at least a portion of the second data is based on the first data, and transmitting the second data. The computing device 600 can facilitate, in whole or in part, defining a plurality of zones, wherein each zone of the plurality of zones is associated with a respective range of values for at least one wireless network performance characteristic of a wireless network, obtaining a request from a communication device associated with an operator of the wireless network, the request pertaining to a specified location that is included within at least one zone of the plurality of zones, based on the obtaining of the request, obtaining data that is representative of a performance of the wireless network within the at least one zone, and transmitting second data to the communication device, wherein the second data is based on the data. The computing device 600 can facilitate, in whole or in part, transmitting, by a processing system including a processor, a request for information associated with operations of a first wireless network, obtaining, by the processing system and based on the transmitting of the request, first data pertaining to a first performance characteristic of the first wireless network and second data pertaining to a second performance characteristic of a second wireless network, processing, by the processing system, the first data and the second data to generate a presentation that includes a representation of the first performance characteristic and the second performance characteristic, and presenting, by the processing system, the presentation.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
obtaining first data;
analyzing the first data to delineate a plurality of zones including a first zone and a second zone, wherein the first zone and the second zone are distinguishable from one another in terms of at least one wireless network performance characteristic;
obtaining, from a communication device, a request for wireless network performance data pertaining to a specified location that is within a threshold distance of the first zone, the second zone, or a combination thereof;
based on the obtaining of the request, processing the request to identify second data corresponding to the wireless network performance data, wherein at least a portion of the second data is based on the first data; and
transmitting the second data.

2. The device of claim 1, wherein the transmitting of the second data comprises transmitting the second data to the communication device, a second communication device, or a combination thereof.

3. The device of claim 1, wherein the communication device is associated with a technician or an engineer of a network operator.

4. The device of claim 1, wherein the second data includes third data that is absent from the first data.

5. The device of claim 1, wherein the first zone is based on first data points included in the first data that are within a first threshold of one another, and wherein the second zone is based on second data points included in the first data that are within a second threshold of one another.

6. The device of claim 1, wherein the transmitting of the second data facilitates a presentation of the wireless network performance data.

7. The device of claim 6, wherein the presentation of the wireless network performance data comprises a presentation of the wireless network performance data as an augmented reality presentation, a virtual reality presentation, or a combination thereof.

8. The device of claim 6, wherein the presentation of the wireless network performance data comprises a presentation of the wireless network performance data as an overlay on top of an image of a scene corresponding to the specified location.

9. The device of claim 8, wherein the image of the scene is a live scene corresponding to where the communication device is located.

10. The device of claim 1, wherein the request for wireless network performance data pertains to wireless devices of a specified configuration.

11. The device of claim 10, wherein the specified configuration is specified in terms of a make and a model.

12. The device of claim 10, wherein the specified configuration is specified in terms of a version of an application, a version of an operating system, or a combination thereof.

13. The device of claim 1, wherein the request for wireless network performance data pertains to a specified date, a specified time, a specified range of dates, a specified range of times, or any combination thereof.

14. The device of claim 1, wherein the operations further comprise:
subsequent to the analyzing the first data, obtaining third data; and
analyzing at least the third data to modify the plurality of zones, resulting in a modified plurality of zones that is at least partially different from the plurality of zones, wherein the modified plurality of zones includes a first modified zone and a second modified zone.

15. The device of claim 14, wherein the operations further comprise:
obtaining, from the communication device or a second communication device, a second request for second wireless network performance data pertaining to a second specified location that is within a threshold distance of the first modified zone, the second modified zone, or a combination thereof;
based on the obtaining of the second request, processing the second request to identify fourth data corresponding to the second wireless network performance data, wherein at least a portion of the fourth data is based on the first data, the third data, or a combination thereof; and
transmitting the fourth data.

16. A non-transitory machine-readable medium, comprising executable instructions that, when executed by a processing system including a processor, facilitate performance of operations, the operations comprising:
defining a plurality of zones, wherein each zone of the plurality of zones is associated with a respective range of values for at least one wireless network performance characteristic of a wireless network;
obtaining a request from a communication device associated with an operator of the wireless network, the request pertaining to a specified location that is included within at least one zone of the plurality of zones;
based on the obtaining of the request, obtaining data that is representative of a performance of the wireless network within the at least one zone; and
transmitting second data to the communication device, wherein the second data is based on the data.

17. The non-transitory machine-readable medium of claim 16, wherein the operations further comprise:
based on the obtaining of the data, processing the data to generate the second data, wherein the second data facilitates a presentation at the communication device of the performance of the wireless network within the at least one zone.

18. The non-transitory machine-readable medium of claim 17, wherein the presentation includes an augmented reality presentation, a virtual reality presentation, or a combination thereof, and wherein the presentation includes a digital representation of an object that is generated via a use of Light Detection and Ranging (LiDAR) technology.

19. A method, comprising:
transmitting, by a processing system including a processor, a request for information associated with operations of a first wireless network;
obtaining, by the processing system and based on the transmitting of the request, first data pertaining to a first performance characteristic of the first wireless network and second data pertaining to a second performance characteristic of a second wireless network;
processing, by the processing system, the first data and the second data to generate a presentation that includes a representation of the first performance characteristic and the second performance characteristic; and
presenting, by the processing system, the presentation.

20. The method of claim 19, wherein the presenting of the presentation comprises presenting the presentation as a visual presentation, wherein the first wireless network includes a cellular network, wherein the second wireless network includes a Wi-Fi network, wherein as part of the visual presentation the first performance characteristic is delineated as a first zone, wherein as part of the visual presentation the second performance characteristic is delineated as a second zone, wherein the first performance characteristic includes a first signal strength, and wherein the second performance characteristic includes a second signal strength, the method further comprising:
subsequent to the presenting, obtaining, by the processing system, an indication of a proposed modification to the first wireless network;
transmitting, by the processing system, the indication of the proposed modification to a network node;
obtaining, by the processing system and from the network node, third data that includes an indication in a change in a value included in the first performance characteristic from a first value to a second value that is different from the first value;
processing, by the processing system, at least the third data to generate a second presentation that includes a representation of the second value, the change in the value, or a combination thereof; and
presenting, by the processing system, the second presentation.
